(19) United States
(12) Patent Application Publication
(10) Pub. No.: US 2011/0031986 A1
(43) Pub. Date: Feb. 10, 2011

(54) Sub-Threshold Capfet Sensor for Sensing Analyte, A Method and System Thereof

(76) Inventors: Navakanta Bhat, Karnataka (IN); Balaji Jayaraman, Karnataka (IN); S.A. Shivashankar, Karnataka (IN); Rudra Pratap, Karnataka (IN)

Correspondence Address: DLA PIPER LLP (US), 4365 EXECUTIVE DRIVE, SUITE 1100, SAN DIEGO, CA, 92121-2133, US

(21) Appl. No.: 12/937,243

(22) PCT Filed: Jun. 19, 2008
(86) PCT No.: PCT/IN08/00385

§ 371 Date: Oct. 8, 2010

(30) Foreign Application Priority Data
Apr. 11, 2008 (IN) 00906/CHE/2008

(51) Int. Cl. G01N 27/22

(52) U.S. Cl. 324/686

(57) ABSTRACT

The present invention relates to high sensitivity chemical sensors, more particularly relates to high sensitivity chemical sensors which are capacitively coupled, FET based analyte sensors. A sub-threshold capacitively coupled Field Effect Transistor (CapFET) sensor for sensing an analyte comprises fixed dielectric placed on substrate of the CapFET and second dielectric sensitive to the analyte, placed between gate terminal of the CapFET and the fixed dielectric, wherein presence of the analyte alters either dielectric constant of the second dielectric or work function of the gate.

### FIELD OF THE INVENTION

The present invention relates to high sensitivity chemical sensors, more particularly relates to high sensitivity chemical sensors which are capacitively coupled, FET based analyte sensors.

### BACKGROUND OF THE INVENTION

Chemical/Biosensors find applications in various fields like environment monitoring, medical industries, clinical diagnosis and food processing. In particular, gas sensing at low concentration levels is a key requirement in electronic noses and industrial environment quality characterization. It is often desirable to have sensors with detection limits close to ppb range, as in the case of organic contaminant monitoring in Extreme Ultra Violet (EUV) lithography equipments. It is extremely challenging to obtain such a high resolution from a conventional sensor which produces a linear change in its output. There are different solutions proposed for gas sensors. Metal oxide semiconductors based gas sensors [1] work on the principle of gas-induced conductance modulation. Adsorption of the target gas on to the sensor film results in a change in its electrical resistance. They work at an elevated temperature of around 300-400° C. Polymers have also been used for gas sensing applications. Conducting polymers like polyaniline, pentacene and polyhexylthiophene have been explored for sensing volatile organic compounds. The conductivity of the polymer film varies in accordance with the target analyte adsorption. There are two variants that are explored in the context of conducting polymers. Conducting polymer based chemiresistors have their resistance modulated based on the target analyte adsorption, while conducting polymer based ChemFETs have the polymer deposited in the channel region whose conductivity gets modulated in the presence of target analyte.

There have been different approaches followed in the literature to achieve a capacitive coupled analyte sensor. For an example, in a polyetherurethane based capacitive analyte sensor proposed in [2] the polymer material is deposited between two interdigitated electrodes. The adsorption of target analyte on the polymer results in a change in either its thickness or its dielectric constant which leads to a change in the capacitance which is read out using a fully differential sigma delta converter providing more than 18 bits of accuracy. Two different Field Effect Transistor (FET) structures working on the principle of analyte-induced work function modulation is reviewed and integrated in [3]. The first configuration, called Lundstrom FET, has a sensitive layer (Palladium film for Hydrogen sensing) deposited directly on top of the transistor channel. The second configuration, called Suspended gate FET, has an analyte sensitive layer placed on a substrate (or gate) suspended at a certain distance above the active FET region, with an air gap between channel and layer for the analyte to reach the sensitive layer. In both these designs, in the presence of the target analyte, there will be a change in the work function at the sensitive layer interface, which leads to shift in the threshold voltage (VT) of the transistor. The threshold voltage shift causes the drain-to-source current to vary. In general, the FET is operated in either the linear or saturation region wherein, the drain current is either a linear or quadratic function of the gate overdrive voltage respectively.

An electrochemical capacitor based analyte sensor for sensing volatile organic/inorganic compounds with an ionic liquid as the sensing material is proposed in [4]. When exposed to environment containing the target analyte, the volatile compound gets dissolved in the ionic liquid and gets adsorbed on the surface of the electrodes and effects a change in the electric double layer capacitance. The sensor has a larger base capacitance and the change in capacitance is of the order of few hundreds of pF/ppm and hence relaxes the requirements on the signal-conditioning circuitry.

Different types of transducers (mass-sensitive, thermal, optical, electrochemical) based on different working principles like mass-change, temperature change due to chemical interaction, change in light intensity by absorption, and change in potential or resistance through charge transfer, exist for biosensing applications [5]. In the case of electrochemical biosensors, which exhibit better detection limits than the other sensors [6], the chemical changes take place at the electrodes or in the probed sample volume, and the resulting charge or current is measured.

FET based sensors are reviewed for new devices are given in [7]. Ion Sensitive Field Effect Transistors (ISFETs) are gate-less devices immersed in appropriate solution, for pH sensing applications. The threshold voltage of the transistor is modulated by the change in surface-potential at the oxide solution interface. In another modification to conventional FET, an insulating organic layer with functional groups attached to it can replace the oxide layer, resulting in chemically sensitive FET (ChemFETs). These FET sensors are operated in the linear region wherein the transistor drain current varies linearly with the sensor signal.

### Limitations of Prior Art

Metal oxide based gas sensors are not power efficient as substantial amount of energy is spent on heating the device to an appropriate temperature. The conventional resistive and capacitive chemical/biosensors response is linear and hence it is difficult to obtain high sensitivity. Sensors described in [3], which work on the principle of work-function modulation depend essentially on the interface between the metal and the oxide layer. Further, the transistors in the reported sensors are operated in the triode region leading to a linear response. Though the sensor proposed in [4] has a relatively larger change in capacitance per ppm concentration of analyte, the requirement of an electrochemical system with ionic liquid filled in the recessed area poses a challenge in scaling the device dimensions and integrating it with electronic circuit. The FET based sensors reported in [7] are operated in the linear region, similar to those in [3]. Hence it is challenging to obtain low detection limits with high sensitivity.

### OBJECTS OF THE INVENTION

The principal object of the present invention is to develop a sub-threshold Capacitively coupled Field Effect Transistor (CapFET) sensor for sensing an analyte.

Another object of the invention is to develop fixed dielectric placed on substrate of the CapFET.

Still another object of the invention is to develop second dielectric sensitive to the analyte, placed between gate terminal of the CapFET and the fixed dielectric, wherein presence of the analyte alters either dielectric constant of the second dielectric or work function of the gate.

Still another object of the invention is to provide for a method to sense analyte using sub-threshold CapFET sensor.

Still another object of the invention is to develop a system to detect presence of analyte.

### STATEMENT OF THE INVENTION

Accordingly the invention provides for a sub-threshold Capacitively coupled Field Effect Transistor (CapFET) sensor for sensing an analyte comprising: fixed dielectric placed on substrate of the CapFET, and second dielectric sensitive to the analyte, placed between gate terminal of the CapFET and the fixed dielectric, wherein presence of the analyte alters either dielectric constant of the second dielectric or work function of the gate, the invention also provides for a method to sense analyte using sub-threshold CapFET sensor comprising an act of observing change in drain current (I_{D}) of the sensor due to change in either dielectric constant (K) of second dielectric or work function of gate material, by presence of the analyte and also provides for a system to detect presence of analyte comprising: a sub-threshold CapFET sensor having a fixed dielectric on substrate of the CapFET, and a second dielectric sensitive to analyte, placed between gate terminal of the CapFET and the fixed dielectric, wherein the presence of the analyte or flow of fluid alters either dielectric constant of the second dielectric or work function of the gate, resulting in an exponential change in the drain current (I_{D}) of the sensor, a means to operate the sensor in sub-threshold region by applying constant gate-to-source voltage (V_{GS}), wherein the voltage (V_{GS}) is less than threshold voltage (V_{T}) of the sensor, and a means to sense the change in drain current (I_{D}) to detect the presence of analyte.

### BRIEF DESCRIPTION OF THE ACCOMPANYING DRAWINGS

FIG. 1 shows cross sectional view of the sensor device.

FIG. 2 shows graph of I_{D}-V_{GS} characteristics for FET with different silicon film thicknesses.

FIG. 3(a) shows graph of sensitivity of the device operated in sub-threshold region.

FIG. 3(b) shows graph of sensitivity of the device operated in saturation region.

### DETAILED DESCRIPTION OF THE INVENTION

The present invention is in relation to a sub-threshold Capacitively coupled Field Effect Transistor (CapFET) sensor for sensing an analyte comprising: fixed dielectric placed on substrate of the CapFET, and second dielectric sensitive to the analyte, placed between gate terminal of the CapFET and the fixed dielectric, wherein presence of the analyte alters either dielectric constant of the second dielectric or work function of the gate.

In yet another embodiment of the present invention the second dielectric is selected from a group comprising analyte-sensitive film, fluid and air.

In still another embodiment of the present invention the analyte is selected from a group comprising gas, bio-particles and fluid.

In still another embodiment of the present invention the dielectric constant of the fluid is changed due to change in concentration of relative constituents of the fluid.

In still another embodiment of the present invention presence or absence of the fluid under the gate determines the effective dielectric constant of the layer.

In still another embodiment of the present invention the absence of the fluid under the gate is filled with air.

In still another embodiment of the present invention said sensors are arranged in an array to extract velocity of the fluid.

In still another embodiment of the present invention the alteration in dielectric constant of the second dielectric due to presence of the analyte varies gate capacitance of the sensor.

In still another embodiment of the present invention the gas flows between the gate terminal of the CapFET biased in sub-threshold region and the fixed dielectric and gets adsorbed on the gate, leading to change in the work function of the gate.

In still another embodiment of the present invention the fixed dielectric is selected from a group comprising silicon dioxide, high-K material, preferably silicon dioxide.

In still another embodiment of the present invention the alteration in dielectric constant of the second dielectric or the work function of the gate leads to change in the threshold voltage (V_{T}) of the CapFET biased in sub-threshold region.

In still another embodiment of the present invention the V_{T} is adjusted by varying the substrate doping concentration (N_{A}).

In still another embodiment of the present invention said sensor is operated in sub-threshold region by applying constant gate-to-source voltage (V_{GS}), wherein the gate-to-source voltage (V_{Gs}) is less than threshold voltage (V_{T}) of the sensor.

In still another embodiment of the present invention the alteration in the dielectric constant of the second dielectric or the work function of the gate provides for an exponential change in drain current (I_{D}) of the sensor.

In still another embodiment of the present invention the sensor is built on a Silicon-On-Insulator (SOI) substrate comprising a thin film of Silicon resting on an oxide layer which is buried in the Silicon.

In still another embodiment of the present invention the sensor is operated in fully-depleted (FD) mode for enhanced sensitivity.

In still another embodiment of the present invention the CapFETs sensing layer (T_{Sens}), silicon film T_{Si} and buried-oxide layer (T_{box}) thickness are optimized for predetermined thickness (T_{Ox}) of SiO₂ layer and for a given dielectric constant, to obtain maximum sensitivity.

In still another embodiment of the present invention the substrate is selected from a group of semi-conducting material comprising Germanium, Silicon and Gallium Arsenide.

In still another embodiment of the present invention said sensor is integrated into standard CMOS process flow on a SOI substrate.

In still another embodiment of the present invention the sensor is implemented as Partially Depleted SOI (PDSOI) or Dynamically Depleted SOI (DDSOI), or bulk MOSFET or other similar device structure.

In still another embodiment of the present invention said sensor is implemented either with Polysilicon gate and diffused source/drain junctions or with metal gate and Schottky source/drain junctions, or any combination thereof.

The present invention is in relation to a method to sense analyte using sub-threshold CapFET sensor comprising an act of observing change in drain current (I_{D}) of the sensor due to change in either dielectric constant (K) of second dielectric or work function of gate material, by presence of the analyte.

In still another embodiment of the present invention the change in either the dielectric constant of the second dielectric or the work function of the gate material depends on the presence of the analyte or the flow of fluid.

In still another embodiment of the present invention the sensor is operated in sub-threshold region by applying constant gate-to-source voltage (V_{GS}), wherein the voltage (V_{GS}) is less than threshold voltage (V_{T}) of the sensor.

In still another embodiment of the present invention the change in drain current (I_{D}) is exponential.

The present invention is in relation to a system to detect presence of analyte comprising: a sub-threshold CapFET sensor having a fixed dielectric on substrate of the CapFET, and a second dielectric sensitive to analyte, placed between gate terminal of the CapFET and the fixed dielectric, wherein the presence of the analyte or flow of fluid alters either dielectric constant of the second dielectric or work function of the gate, resulting in an exponential change in the drain current (I_{D}) of the sensor, a means to operate the sensor in sub-threshold region by applying constant gate-to-source voltage (V_{GS}), wherein the voltage (V_{GS}) is less than threshold voltage (V_{T}) of the sensor, and a means to sense the change in drain current (I_{D}) to detect the presence of the analyte.

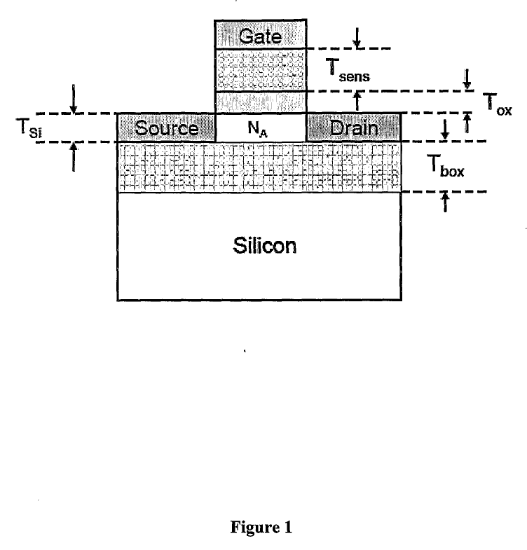

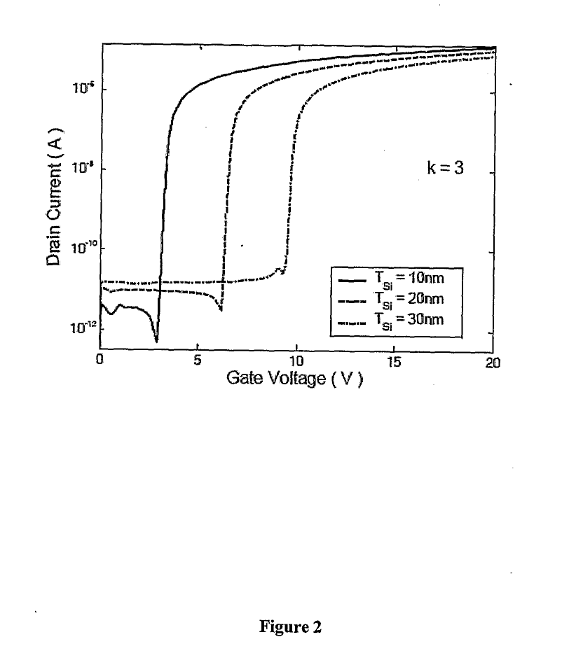

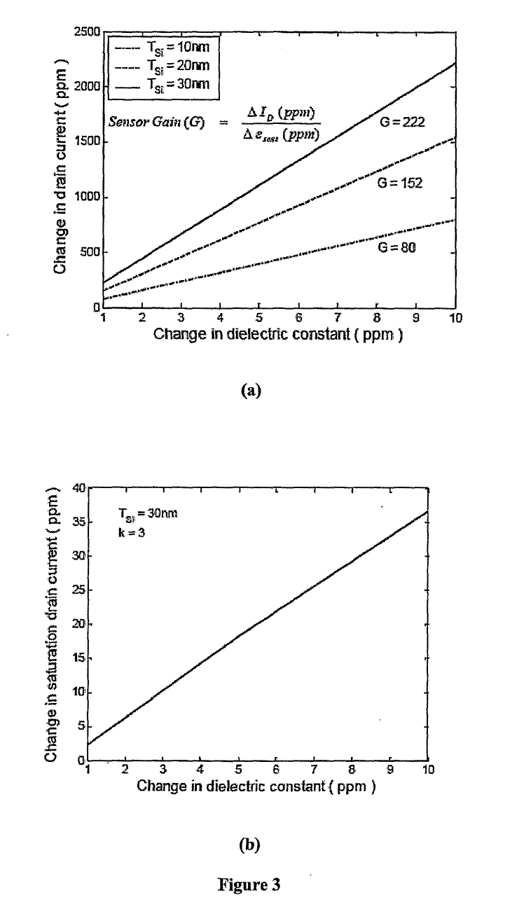

The present invention achieves a high sensitivity to the target analyte (e.g. gas or a bio-particle). A sub-threshold capacitively coupled FET (CapFET) sensor with a stack of two dielectrics is used as the analyte sensing device. FIG. 1 gives the cross-sectional view of the device. The bottom dielectric is silicon dioxide which forms a good interface with underlying Silicon substrate, however any other dielectric (high-K or otherwise) that gives a good interface with silicon is used. The analyte sensitive dielectric material is deposited over silicon dioxide. The resultant device has a structure similar to a conventional FET, with an additional analyte sensing dielectric introduced in the gate stack. The effective gate capacitance is the series combination of sensor layer capacitance (C_{SENS}) and oxide capacitance (C_{OX}). The thickness of the oxide layer (T_{Ox}) is made much smaller compared to the thickness of the sensing layer (T_{Sens}) so that the effective gate capacitance is dominated by the sensing layer capacitance. The FET device is operated in the sub-threshold region where the drain current (I_{D}) varies exponentially with gate-to-source voltage (V_{GS}). The device is operated by applying a constant V_{GS}, which is less than the threshold voltage (V_{T}) of the transistor. The drain current forms the sensor response. In the presence of target analyte, the dielectric constant undergoes a change, which results in V_{T} getting modified to V_{T-ANALYTE}. This brings out an exponential change in the drain current leading to high sensitivity. Further, the device is constructed on a Silicon-on-insulator (SOI) substrate with silicon film thickness T_{Si} and buried oxide thickness T_{box}. The V_{T} of the device is adjusted by controlling the substrate doping concentration (N_{A}), T_{Si}, T_{Sens} and T_{Ox}. When the T_{Si} is smaller than the depletion width, effective silicon depletion capacitance goes down in the SOI structure, which enhances the sub-threshold slope of the transistor, enabling the sensor to achieve even higher degree of sensitivity. In this mode of operation (fully-depleted), the entire silicon film below the gate stack is depleted of mobile charge carriers. There is a trade-off between the operating voltage and silicon film thickness as observed in FIG. 2. Lower T_{Si} results in lower threshold voltages. Further, as seen in FIG. 3, the device simulations indicate that sensitivity improves with T_{Si}. In particular, for a T_{box} of 1 μm, T_{Si} of 30 nm, T_{Sens} of 100 nm, T_{Ox} of 10 nm, N_{A} of 5×10¹⁷/cm³, and base ε_{Sens} value of 3, simulation predicts a 222 ppm change in drain current for a 1 ppm change in ε_{Sens}, thus demonstrating a built-in amplification of 222. The sub-threshold operation enhances the amplification by a factor of 96.8, as compared to the saturation region of operation, which exhibits an amplification of 2.29, as observed in FIG. 3(b). The second dielectric is a fluid (for e.g. a bio-analyte), wherein the changes in relative constituents of the fluid change its effective dielectric constant. The second dielectric layer is also an air-gap through which a fluid (e.g. bio-analyte) can flow. The presence or absence of fluid under the gate region determines the effective dielectric constant of the sensor. In this case, an array of CapFETs is used to measure the velocity of the fluid from the obtained time-domain response. Yet another variant of the proposed design is to have an air-gap in the place of second dielectric, and allow the target analyte to get adsorbed onto the gate material. This brings about a change in the work function of the gate material, which in-turn leads to shift in V_{T} of the CapFET. In all the above listed variants, the sensor is operated in sub-threshold region to achieve enhanced sensitivity. The device can be easily integrated with the CMOS signal conditioning electronic circuit. The sensing material deposition (dielectric layer or an air-gap) and gate electrode formation is realized through post-processing steps in a standard CMOS process flow on an SOI substrate.

### REFERENCES

[1] Peter McGeehin et al., “Semiconducting oxide gas sensors,” U.S. Pat. No. 6,046,054, Apr. 4, 2000.
[2] C. Hagleitner et al., “Smart single-chip gas sensor microsystem,” Nature, Vol. 414, pp. 293-296, Nov. 15, 2001.
[3] Ch. Wilbertz et al., “Suspended gate and Lundstrom FET integrated on a CMOS chip,” Sensors and Actuators A 123-124 (2005) 2-6.
[4] Shannon Mark Mahurin et al., “Method and apparatus for detection of chemical vapours,” U.S. Pat. No. 7,217,354 B2, May 15, 2007.
[5] A. Hierlemann et al., “Microfabrication techniques for chemical/biosensors,” Proc. of the IEEE, vol. 91, no. 6, pp. 839-863, 2003.
[6] C. Berggren et al., “Capacitive biosensors,” Electroanalysis 13, no. 3, pp. 173-180, 2001.
[7] W. Olthuis, “Chemical and physical FET-based sensors or variations on an equation,” Sensors and Actuators B 105, pp. 96-103, 2005.

1. A sub-threshold Capacitively coupled Field Effect Transistor (CapFET) sensor for sensing an analyte comprising:
a. fixed dielectric placed on substrate of the CapFET, and
b. second dielectric sensitive to the analyte, placed between gate terminal of the CapFET and the fixed dielectric, wherein presence of the analyte alters either dielectric constant of the second dielectric or work function of the gate.

2. The sensor as claimed in claim 1, wherein the second dielectric is selected from a group comprising analyte-sensitive film, fluid and air.

3. The sensor as claimed in claim 1, wherein the analyte is selected from a group comprising gas, bio-particles and fluid.

4. The sensor as claimed in claim 1, wherein the dielectric constant of the fluid is changed due to change in concentration of relative constituents of the fluid.

5. The sensor as claimed in claim 2, wherein presence or absence of the fluid under the gate determines the effective dielectric constant of the layer.

6. The sensor as claimed in claim 5, wherein the absence of the fluid under the gate is filled with air.

7. The sensor as claimed in claims 1, wherein said sensor arranged in an array to extract velocity of the fluid.

8. The sensor as claimed in claim 1, wherein the alteration in dielectric constant of the second dielectric due to presence of the analyte varies gate capacitance of the sensor.

9. The sensor as claimed in claim 3, wherein the gas flows between the gate terminal of the CapFET biased in sub-threshold region and the fixed dielectric and gets adsorbed on the gate, leading to change in the work function of the gate.

10. The sensor as claimed in claim 1, wherein the fixed dielectric is selected from a group comprising silicon dioxide, high-K material, preferably silicon dioxide.

11. The sensor as claimed in claim 1, wherein the alteration in dielectric constant of the second dielectric or the work function of the gate leads to change in the threshold voltage (V_{T}) of the CapFET biased in sub-threshold region.

12. The sensor as claimed in claim 11, wherein the V_{T} adjusted by varying the substrate doping concentration (N_{A}).

13. The sensor as claimed in claim 1, wherein said sensor is operated in sub-threshold region by applying constant gate-to-source voltage (V_{GS}), wherein the gate-to-source voltage (V_{GS}) is less than threshold voltage (V_{T}) of the sensor.

14. The sensor as claimed in claim 1, wherein the alteration in the dielectric constant of the second dielectric or the work function of the gate provides for an exponential change in drain current (I_{D}) of the sensor.

15. The sensor as claimed in claim 1, wherein the sensor is built on a Silicon-On-Insulator (SOI) substrate comprising a thin film of Silicon resting on an oxide layer which is buried in the Silicon.

16. The sensor as claimed in claim 1, wherein the sensor is operated in fully-depleted (FD) mode for enhanced sensitivity.

17. The sensor as claimed in claim 1, wherein the CapFETs sensing layer (T_{Sens}) silicon film (T_{Si}) and buried-oxide layer (T_{box}) thickness are optimized for redetermined thickness (T_{Ox}) of SiO₂ layer and for a given dielectric constant, to obtain maximum sensitivity.

18. The sensor as claimed in claim 1, wherein the substrate is selected from a group of semi-conducting material comprising Germanium, Silicon and Gallium Arsenide.

19. The sensor as claimed in claim 1, wherein said sensor is integrated into standard CMOS process flow on a SOI substrate.

20. The sensor as claimed in claim 1, wherein the sensor is implemented as Partially Depleted SOI (PDSOI) or Dynamically Depleted SOI (DDSOI), or bulk MOSFET or other similar device structure.

21. The sensor as claimed in claim 1, wherein said sensor is implemented either with Polysilicon gate and diffused source/drain junctions or with metal gate and Schottky source/drain junctions, or any combination thereof.

22. A method to sense analyte using sub-threshold CapFET sensor comprising an act of observing change in drain current (I_{D}) of the sensor due to change in either dielectric constant (K) of second dielectric or work function of gate material, by presence of the analyte.

23. The method as claimed in claim 22, wherein the change in either the dielectric constant of the second dielectric or the work function of the gate material depends on the presence of the analyte or the flow of fluid.

24. The method as claimed in claim 22, wherein the sensor is operated in sub-threshold region by applying constant gate-to-source voltage (V_{GS}), wherein the voltage (V_{GS}) is less than threshold voltage (V_{T}) of the sensor.

25. The method as claimed in claim 22, wherein the change in drain current (I_{D}) is exponential.

26. A system to detect presence of analyte comprising:
a. a sub-threshold CapFET sensor having a fixed dielectric on substrate of the CapFET, and a second dielectric sensitive to analyte, placed between gate terminal of the CapFET and the fixed dielectric, wherein the presence of the analyte or flow of fluid alters either dielectric constant of the second dielectric or work function of the gate, resulting in an exponential change in the drain current (I_{D}) of the sensor,
b. a means to operate the sensor in sub-threshold region by applying constant gate-to-source voltage (V_{GS}), wherein the voltage (V_{GS}) is less than threshold voltage (V_{T}) of the sensor, and
c. a means to sense the change in drain current (I_{D}) to detect the presence of the analyte.
